(19) United States
(12) Patent Application Publication
(10) Pub. No.: US 2019/0084085 A1
(43) Pub. Date: Mar. 21, 2019

(54) WELDING METHOD

(71) Applicant: MITSUBISHI HEAVY INDUSTRIES MACHINE TOOL CO., LTD., Ritto-shi, Shiga (JP)

(72) Inventors: Yasuyuki FUJIYA, Tokyo (JP); Masao WATANABE, Ritto-shi (JP)

(73) Assignee: MITSUBISHI HEAVY INDUSTRIES MACHINE TOOL CO., LTD., Ritto-shi, Shiga (JP)

(21) Appl. No.: 16/082,864

(22) PCT Filed: May 8, 2017
(86) PCT No.: PCT/JP2017/017329

§ 371 Date: Sep. 6, 2018

(30) Foreign Application Priority Data
Jun. 1, 2016 (JP) 2016-109936

(51) Int. Cl. B23K 26/21; B23K 15/00

(52) U.S. Cl. CPC B23K 26/21; B23K 15/0046

(57) ABSTRACT

A welding method for welding a cast iron (first member) and a steel (second member) having a lower hardness than the cast iron, which comprises: a first step for inserting an insert material (third member) having a lower hardness than the steel between the cast iron and the steel; a second step for welding the boundary portion between the cast iron and the insert material; and a third step for welding the boundary portion between the steel and the insert material. Consequently, this welding method is able to improve the strength characteristics after welding.

### TECHNICAL FIELD

The present invention relates to a welding method. Particularly, the present invention relates to a cast iron welding method when a product having a weld structure between a part formed of a cast iron and a part formed of a steel is manufactured, for example, a weld structural part of a plurality of members represented by a differential ring gear, a differential case, or the like in a differential gear of an automobile as a functional part or a case is manufactured.

### BACKGROUND ART

A drive system part of an automobile requires high strength, and thus, a strong steel, a cast iron, or the like is used, and a method is adopted in which a part made by plastic working or casting is assembled by a bolt fastening structure.

If this mechanical fastening structure can be replaced by a fastening structure by welding, it is possible to reduce weight. However, in welding between a cast iron and a steel, cracks easily occur due to fragile textures generated by phase transformation occurring molten and solidified portions and the vicinities thereof or stress generated by thermal expansion or shrinkage.

Accordingly, in welding of the cast iron in the related art, a method of performing welding while supplying an austenitic welding wire such as a Ni wire.

FIG. 4 is a schematic sectional view showing a state where a cast iron and a steel are welded to each other in this manner. An austenitic welding metal 43 is formed between a cast iron 11 and a steel 12 by a welding wire.

### CITATION LIST

### Patent Literature

[PTL 1] Japanese Patent No. 5293840

### SUMMARY OF INVENTION

### Technical Problem

However, in the above-described method, even when cracks are prevented during the welding, hardening of a heat affected zone by welding cannot be avoided, and in this welded state, a hardened fragile region (a phase configured of ledeburite and martensite) becomes a fracture starting point, reliability of a weld zone decreases, and thus, it is necessary to perform heat treatment after the welding.

In addition, PTL 1 discloses a technology of forming a cavity in a joint portion in advance.

The present invention is made in consideration of the above-described technical problem, and an object thereof is to provide a welding method capable of improving strength characteristics.

### Solution to Problem

In order to achieve the above-described object, according to a first invention, there is provided a welding method for welding a first member and a second member having a hardness lower than that of the first member, comprising: a first step of inserting a third member having a hardness lower than that of the second member into a portion between the first member and the second member; a second step of welding a boundary portion between the first member and the third member; and a third step of welding a boundary portion between the second member and the third member.

In order to achieve the above-described object, according to a second invention, in the welding method according to the first invention, the welding method further includes a fourth step of welding a center of the third member. In addition, in order to achieve the above-described object, according to a third invention, in the welding method according to the first or second invention, the welding is performed using a high energy beam in the steps other than the first step.

### Advantageous Effects of Invention

According to the welding method of the present invention, it is possible to improve strength characteristics.

### BRIEF DESCRIPTION OF DRAWINGS

FIGS. 1A to 1C are schematic sectional view for explaining a welding method according to Embodiment 1 of the present invention. FIG. 1A shows a state where an insert material is inserted, FIG. 1B shows a state after a first pass welding, and FIG. 1C shows a state after a second pass welding.

FIGS. 2A and 2B are schematic sectional view for explaining a welding method according to Embodiment 2 of the present invention. FIG. 2A shows a state after a second pass welding and FIG. 2B shows a state after a third pass welding.

FIGS. 3A to 3C are schematic sectional view for explaining a welding method according to Embodiment 3 of the present invention. FIG. 3A shows a state where a welding wire protrudes to the vicinity of a V-shaped groove. FIG. 3B shows a state after a first pass welding, and FIG. 3C shows a state after a second pass welding.

FIG. 4 is a schematic sectional view showing a state after welding by a method of the related art.

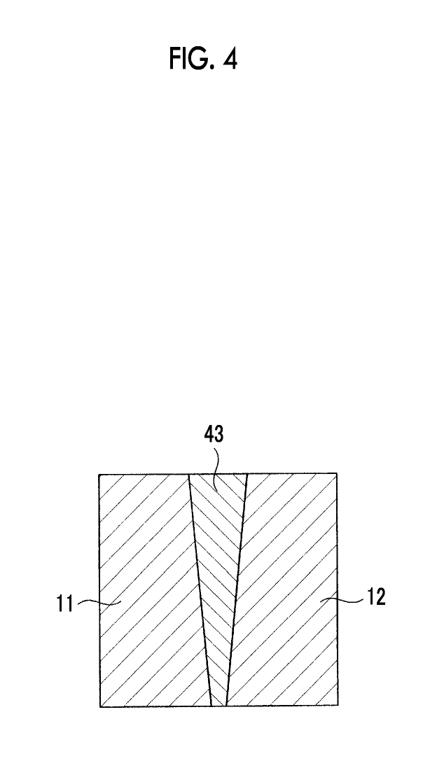

### DESCRIPTION OF EMBODIMENTS

Hereinafter, Embodiments of a welding method according to the present invention will be described with reference to the drawings.

### Embodiment 1

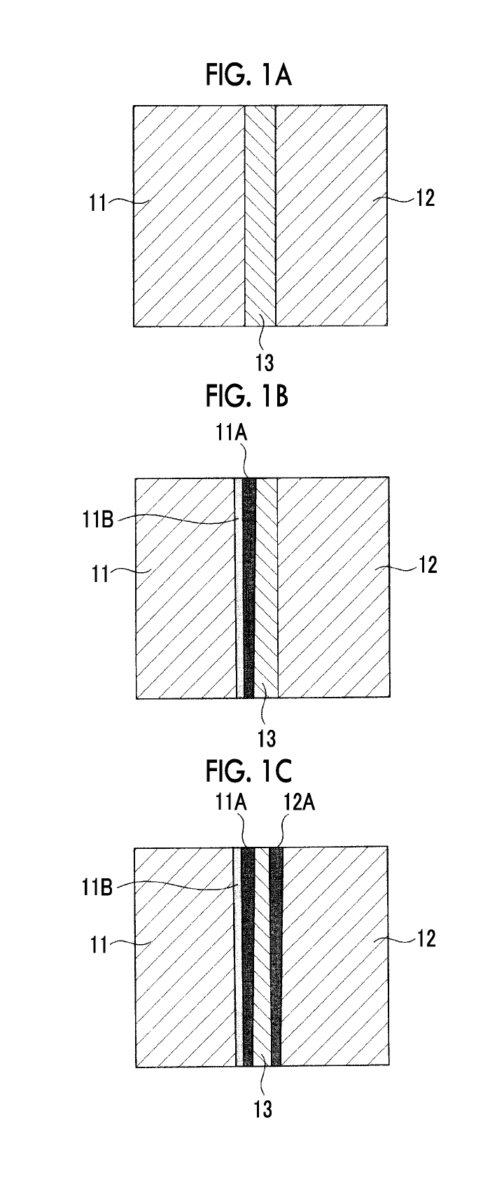

FIGS. 1A to 1C are schematic sectional view for explaining a welding method according to the present embodiment. FIG. 1A shows a state where an insert material is inserted, FIG. 1B shows a state after a first pass welding, and FIG. 1C shows a state after a second pass welding.

In the welding method according to the present embodiment, when a part formed of a cast iron and a part formed of a steel are welded to each other, first, as shown in FIG. 1A, an insert material 13 which is an austenitic material such as Ni or austenitic stainless steel is inserted into a portion between a cast iron 11 and a steel 12 (first step). Hardness of the steel 12 (second member) is lower than that of the cast iron 11 (first member), and hardness of the insert material 13 (third member) is lower than that of the steel 12. In particular, in an iron-based member, as hardness increases, brittleness increases (becomes brittle), and as the hardness decreases, the brittleness decreases (becomes not brittle and becomes tenacious). In the present embodiment, the respective members have the above-described relationships.

Next, as first pass welding, a boundary portion between the cast iron 11 and the insert material 13 is welded by a high energy beam such as a laser beam or an electron beam from an upper side of a paper surface of FIG. 1A (second step). Accordingly, as shown in FIG. 1B, a weld zone 11A is formed in the boundary between the cast iron 11 and the insert material 13, and a heat affected zone 11B is formed on the cast iron 11 side due to the weld zone 11A. As described previously, the heat affected zone 11B is a hardened fragile zone.

In addition, as second pass welding, a boundary portion between the steel 12 and the insert material 13 is welded by a high energy beam from an upper side of a paper surface of FIG. 1B (third step). Accordingly, as shown in FIG. 10, a weld zone 12A is formed in the boundary between the steel 12 and the insert material 13. In addition, the heat affected zone 11B of the cast iron 11 formed by the first pass welding is tempered by heat conduction of the second pass welding. Accordingly, it is possible to decrease hardening of the heat affected zone 11B.

In the present embodiment, according to the above-described method, it is possible to decrease hardness of the heat affected zone 11B on the cast iron 11 side having very high hardness, and thus, it is possible to prevent cracks and improve strength characteristics.

Moreover, in the second pass welding, the heat affected zone is formed on the steel 12 side by the weld zone 12A. However, this heat affected zone is not hard (not brittle) compared to the heat affected zone 11B on the cast iron side, and thus, this is not mentioned in the present embodiment.

### Embodiment 2

In addition to operational effects of Embodiment 1, in the present embodiment, the hardness of the heat affected zone on the steel 12 side formed by the second pass welding decreases. Hereinafter, a procedure up to the second pass welding in this embodiment is the same as that of the first embodiment, and thus, descriptions thereof will be omitted, and descriptions after the second pass welding will be made.

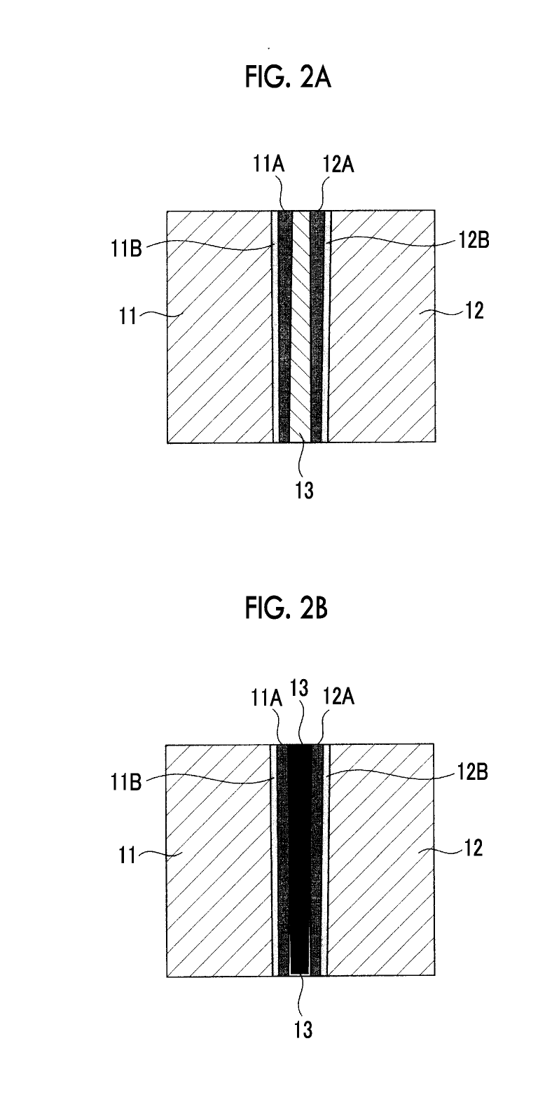

FIGS. 2A and 2B are schematic sectional view for explaining a welding method according to the present embodiment. FIG. 2A shows a state after a second pass welding and FIG. 2B shows a state after a third pass welding.

As shown in FIG. 2A, after the second pass welding described in Embodiment 1, a heat affected zone 12B is formed on the steel 12 side from the weld zone 12A.

In the present embodiment, as third pass welding, the center of the insert material 13, that is, a position equidistant from the weld zone 11A and the weld zone 12A is welded by a high energy beam from an upper side of a paper surface of FIG. 2A (fourth step). Accordingly, as shown in FIG. 2B, a weld zone 13A is formed at the center of the insert material 13. Moreover, in this case, the weld zones 11A and 12A may be melted, but the heat affected zones 11B and 12B should not be melted.

Accordingly, the heat affected zone 11B on the cast iron 11 side formed by the first pass welding and the heat affected zone 12B on the steel 12 side formed by the second pass welding are tempered by heat conduction of the third pass welding. Therefore, it is possible to decrease the hardness of the heat affected zones 11B and 12B.

In the present embodiment, it is possible to decrease the hardness of the heat affected zone 12B on the steel 12 side as well as the hardness of the heat affected zone 11B on the cast iron 11 side having very high hardness, and thus, it is possible to prevent cracks and maintain the strength characteristics.

### Embodiment 3

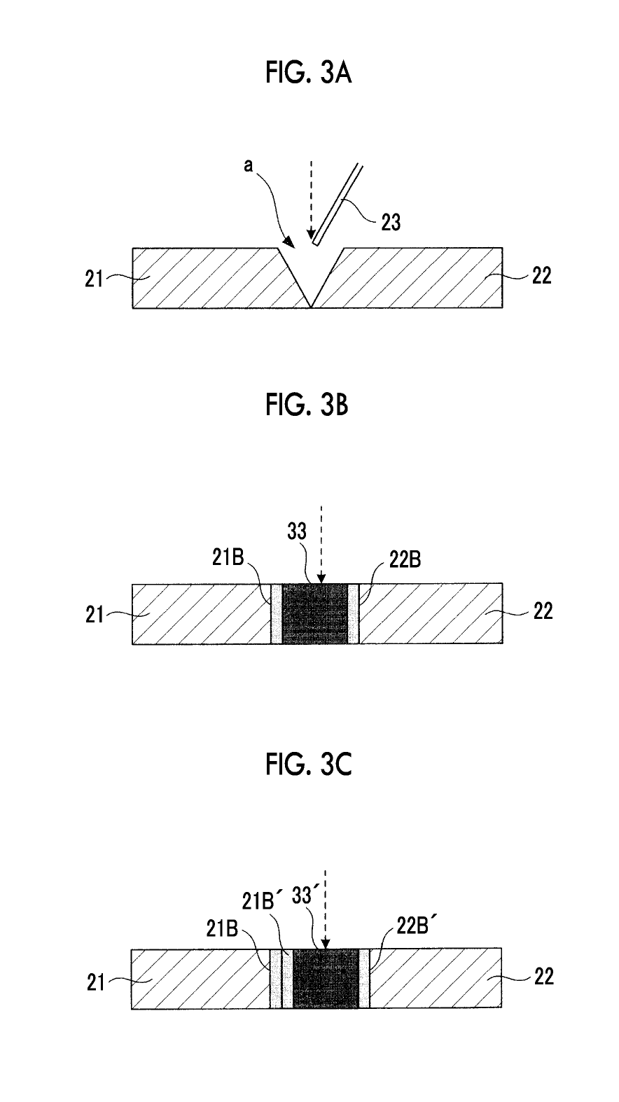

The present embodiment describes a method which is used in a case where a V-shaped groove is formed between a plate-shaped cast iron and a plate-shaped steel and welding is performed. FIGS. 3A to 3C are schematic sectional view for explaining a welding method according to the present embodiment. FIG. 3A shows a state where a welding wire protrudes to the vicinity of a V-shaped groove. FIG. 3B shows a state after a first pass welding, and FIG. 3C shows a state after a second pass welding.

In the welding method according to the present embodiment, as shown in FIG. 3A, first, as a first pass welding, the welding wire 23 is welded by a high energy beam in a direction shown by a broken line arrow in a state where the welding wire 23 protrudes to the V-shaped groove a formed between the plate-shaped cast iron 21 and the plate-shaped steel 22. In this case, the cast iron 21 and the steel 22 around a groove a are simultaneously melted.

Accordingly, as shown in FIG. 3B, a molten metal 33 is formed between the cast iron 21 and the steel 22. In addition, a heat affected zone 21B is formed on the cast iron 21 side from the molten metal 33, and a heat affected zone 22B is formed on the steel 22 side.

Therefore, as shown by a broken line arrow of FIG. 3B, as a second pass welding, a portion of the molten metal 33 close to the heat affected zone 22B on the steel 22 side from the vicinity of an intermediate portion between the heat affected zone 21B on the cast iron 21 side and the heat affected zone 22B on the steel 22 side is welded by a high energy beam. Accordingly, the heat affected zone 21B on the cast iron 21 side formed by the first pass welding is tempered. Therefore, it is possible to decrease the hardness of the heat affected zone 21B on the cast iron 21 side.

As shown in FIG. 3C, a new weld zone 33′ is formed by the second pass welding, a heat affected zone 21B′ is formed on the cast iron 21 side of the weld zone 33′, and a heat affected zone 22B is formed on the steel 22 side. Accordingly, as shown by a broken line arrow, if the welding at the same position as that of the second pass welding is performed by a weakened laser, the heat affected zones 21B′ and 22B′ are tempered. Therefore, it is possible to decrease the hardness of the heat affected zones 21B′ and 22B′.

In the present embodiment, in a case where the V-shaped groove is formed between the plate-shaped cast iron and the plate-shaped steel and the welding is performed, it is possible to decrease the hardness of the heat affected zones 21B and 21B′ on the cast iron 21 side and the hardness of the heat affected zone 22B′ of the steel 22 side, and thus, it is possible to prevent cracks and to maintain the strength characteristics.

### INDUSTRIAL APPLICABILITY

The present invention is suitable for a welding method.

### REFERENCE SIGNS LIST

11: cast iron (first member)
11A: weld zone (on cast iron 11 side)
11B: heat affected zone (on cast iron 11 side)
12: steel (second member)
12A: weld zone (on steel 12 side)
12B: heat affected zone (on steel 12 side)
13: insert material (third member)
21: (plate-shaped) cast iron
21B, 21B′: heat affected zone (on cast iron 21 side)
22: (plate-shaped) steel
22B, 22B′: heat affected zone (on steel 22 side)
23: welding wire
33: molten metal
33′: weld zone
43: insert material

1. A welding method for welding a first member and a second member having a hardness lower than that of the first member, comprising:
a first step of inserting a third member having a hardness lower than that of the second member into a portion between the first member and the second member;
a second step of welding a boundary portion between the first member and the third member; and
a third step of welding a boundary portion between the second member and the third member.

2. The welding method according to claim 1, further comprising:
a fourth step of welding a center of the third member.

3. The welding method according to claim 1,
wherein the welding is performed using a high energy beam in the steps other than the first step.

4. The welding method according to claim 2,
wherein the welding is performed using a high energy beam in the steps other than the first step.
